(19) United States
(12) Patent Application Publication
(10) Pub. No.: US 2012/0295747 A1
(43) Pub. Date: Nov. 22, 2012

(54) STATIONARY CHAIN GUIDE

(75) Inventors: Yuichiri Ishikawa, Osaka (JP); Atsushi Hayami, Osaka (JP); Tadashi Shintani, Osaka (JP)

(73) Assignee: TSUBAKIMOTO CHAIN CO., Osaka (JP)

(21) Appl. No.: 13/468,073

(22) Filed: May 10, 2012

(30) Foreign Application Priority Data
May 16, 2011 (JP) 2011109740

(51) Int. Cl. F16H 7/18

(52) U.S. Cl. 474/140

(57) ABSTRACT

An elongated stationary guide for a traveling transmission chain in an engine such as a timing chain has a narrow reinforcing groove formed along the longitudinal direction of a metal base plate of the guide by surface-pressing, whereby the base plate exhibits plastic deformation. The narrow reinforcing groove extends toward the ends of the base plate past the locations at which the base plate is mounted on an engine block by mounting bolts.

### CROSS REFERENCE TO RELATED APPLICATIONS

This application claims priority on the basis of Japanese Patent Application No. 2011-109740, filed on May 16, 2011. The disclosure of Japanese Patent Application No. 2011-109740 is incorporated by reference.

### FIELD OF THE INVENTION

The invention relates to a stationary guide for sliding contact with a traveling chain such as a timing chain in an automobile engine.

### BACKGROUND OF THE INVENTION

Stationary chain guides have been in common use for guiding the span of a timing chain that travels from a driven camshaft sprocket to a driving sprocket on an engine crankshaft, thereby establishing a predetermined path of travel for the chain. A typical stationary guide is described in Japanese Patent Application Hei. 10-292855, published Nov. 4, 1998. The guide is composed of an elongated base plate, and an elongated shoe supported on the base plate and having a curved surface for sliding contact with the chain as the chain travels along the longitudinal direction of the guide. The stationary guide ensures that the chain travels along a predetermined curved path.

Even though the base plate the conventional stationary guide is made of a steel, there is a possibility that it will bend and deform along its longitudinal direction, or it that its mountings will be broken, due to excessive load applied by the chain, especially if the base plate is used for a long time.

The strength of the base plate can be increased by increasing its thickness. However the increased thickness can bring about installation problems because of limitations on the available space within the timing chain cover of the engine. If an attempt is made to reinforce the conventional base plate to prevent deformation and breakage, it becomes necessary to form the base plate into a complicated configuration, and to utilize special high-strength materials.

### SUMMARY OF THE INVENTION

An aim of the invention is to solve the aforementioned problems and to provide a guide having a base plate that is resistant to deformation and breakage, and that exhibits superior durability, without increasing its thickness, forming it in a complicated configuration, or adopting special high strength materials.

According to a first aspect of the invention, a stationary guide for a transmission chain in an engine comprises an elongated shoe and an elongated metal base plate. The shoe has a front surface for sliding contact with a transmission chain traveling along the direction of elongation of the shoe, and a back surface. The front and back surfaces of the shoe are curved along the direction of elongation of the shoe. The metal base plate also has front and back surfaces, and opposite ends. The base plate extends along the direction of elongation of the shoe, and the front surface of the base plate is in contact with the back surface of the shoe so that the shoe is supported by the base plate. The base plate also includes at least two longitudinally spaced brackets for receiving mounting bolts for mounting the base plate on an engine. The brackets are located along the length of the base plate at locations between the opposite ends of the base plate. At least one of the front and back surfaces of the base plate is plastically deformed to an extent such that it has a narrow reinforcing groove extending along its direction of elongation past both of the brackets toward the opposite ends of the base plate.

The narrow reinforcing groove considerably improves the strength of the base plate by stabilizing its configuration. Therefore, it is possible to ensure stable travel of a transmission chain longitudinally along the guide over a long time without increasing the thickness of the base plate. The reinforcing groove also improves the durability of the base plate by preventing it from being deformed by excessive loads imposed on it by the transmission chain. The narrow reinforcing groove also prevents bending deformation of the base plate along its longitudinal direction, and resists breakage can otherwise occur at the locations of the guide mounting bolts.

When the thin reinforcing groove is formed on the surface of the base plate facing the shoe, the groove functions as an oil passage in which flow of oil can remove heat generated by friction between the transmission chain and the shoe, even in the high temperature environment of an engine.

Because the thin reinforcing groove extends toward the ends of the base plate in both directions past the mounting brackets and therefore beyond the locations of the mounting bolts, the plastically deformed, work-hardened area in the base plate formed by plastic deformation prevents bending deformation of the base plate along its longitudinal direction, and prevents breakage that is otherwise likely to occur at the locations where the base plate is supported on an engine block by mounting bolts.

According to a second aspect of the invention, the narrow reinforcing groove is formed so that the it becomes gradually deeper, proceeding from an intermediate region between the opposite ends of the base plate toward each of the opposite ends. The deepening of the groove toward the ends of the base plate causes work-hardened regions to be formed near the ends of the base plate, preventing bending deformation of the base plate and breakage thereof at the locations of the mounting brackets due to excessive impact resulting from flapping of a free span of the between the guide and a sprocket.

According to a third aspect of the invention, the narrow reinforcing groove can be formed so that the groove becomes gradually deeper, proceeding from each of its opposite ends toward an intermediate region between the opposite ends. Here, a work-hardened area is formed at a central region along the longitudinal direction of the guide, preventing bending deformation of the base plate and breakage thereof at the locations of the mounting brackets when the base plate is subjected to a high load by excessive tension of the transmission chain.

According to a fourth aspect of the invention, the narrow reinforcing groove has bow-shaped ends in the form of concave curves, each extending from the front or back surface in which the groove is formed to the bottom of the groove. The bowed shape of the ends of the groove avoids concentration of stress at the ends of the groove, preventing breakage from starting at the ends of the groove, thereby improving the resistance of the base plate to breakage.

According to a fifth aspect of the invention, at least one of the front and back surfaces of the base plate is plastically deformed to an extent such that it has at least two parallel, narrow, reinforcing groove extending along the direction of elongation of the base plate. Each of these narrow reinforcing grooves extends longitudinally past both of the brackets toward opposite ends of the base plate. The reinforcing grooves are located directly opposite a chain-contact area on the front surface of the shoe on which link plates of a traveling transmission chain are in sliding contact, the chain-contact area having a width substantially equal to the width of the chain. The outermost reinforcing grooves are substantially directly opposite the sides of the chain-contact area.

In the case in which the transmission comprises a traveling transmission chain having laterally spaced sets of link plates, at least one of the front and back surfaces of the base plate is plastically deformed to an extent such that it has two parallel, narrow, reinforcing groove extending along the direction of elongation of the base plate, and each of the narrow reinforcing grooves extends longitudinally past both of the brackets toward opposite ends of the base plate. The chain is in sliding contact with the front surface of the shoe, and the reinforcing grooves are laterally spaced from each other by a distance substantially the same as the distance between the sets of link plates of the chain, each of the two reinforcing grooves being located directly opposite one of the sets of link plates. The base plate can have additional reinforcing grooves.

In each of these two cases of the fifth aspect of the invention, narrow reinforcing grooves are provided at positions on the base plate opposite the positions on the shoe where the link plates of the transmission chain slide. By positioning the reinforcing grooves opposite the chain-contacting locations, improved dissipation of frictional heat is realized, and resistance to deformation of the base plate by the load imposed on the base plate by the link plates is improved.

According to a sixth aspect of the invention, the narrow reinforcing groove is formed in the front surface of the base plate and has a rectangular cross-sectional shape. The reinforcing groove forms an oil passage extending along the longitudinal direction of the guide, through which flow of oil can remove heat generated by friction between the chain and the shoe. To ensure adequate flow of oil, it is desirable to avoid slight narrowing of the groove. If the surface pressing tool is designed to form a groove having a rectangular cross-section, rapid wear of the surface pressing tool during the pressing process can be avoided, and variations in the width of the groove can be minimized.

According to a seventh aspect of the invention, at least one of the front and back surfaces of the base plate is plastically deformed to an extent such that it has at least two parallel, narrow, reinforcing groove extending along the direction of elongation of the base plate. Each of these narrow reinforcing grooves extends longitudinally past both of the brackets toward opposite ends of the base plate. The plural parallel grooves improve the strength of the base plate, and also stabilize and preventing twisting of the base plate.

In each case, the narrow reinforcing groove or grooves are formed by plastically deforming the base plate by exerting compressive stress on one of the front and back surfaces the base plate by means of a surface pressing tool.

### BRIEF DESCRIPTION OF DRAWINGS

FIG. 1 is a schematic front elevational view of the timing drive of an engine, incorporating a stationary guide in accordance with the invention;

FIG. 2 is a side elevational view of a stationary guide according to a first embodiment of the invention, including auxiliary views showing enlargements of end portions of a groove in the back surface of the base plate;

FIG. 3 is a transverse cross-sectional view taken on plane 3-3 in FIG. 2, including an enlarged auxiliary view showing the groove;

FIG. 4 is a transverse cross-sectional view taken on plane 4-4 in FIG. 2, including an enlarged auxiliary view showing the groove;

FIG. 5 is a transverse cross-sectional view taken on plane 5-5 in FIG. 2, including an enlarged auxiliary view showing the groove;

FIG. 6 is a side elevational view of a stationary guide according to a second embodiment of the invention, including auxiliary views showing enlargements of end portions of a groove in the back surface of the base plate;

FIG. 7 is a transverse cross-sectional view taken on plane 7-7 in FIG. 6, including an enlarged auxiliary view showing the groove;

FIG. 8 is a transverse cross-sectional view taken on plane 8-8 in FIG. 6, including an enlarged auxiliary view showing the groove;

FIG. 9 is a transverse cross-sectional view taken on plane 9-9 in FIG. 6, including an enlarged auxiliary view showing the groove;

FIG. 10 is a side elevational view of a stationary guide according to a third embodiment of the invention, including auxiliary views showing enlargements of end portions of a groove in the back surface of the base plate;

FIG. 11 is a transverse cross-sectional view taken on plane 11-11 in FIG. 10, including an enlarged auxiliary view showing the groove;

FIG. 12 is a transverse cross-sectional view of a stationary guide according to a fourth embodiment of the invention, including two auxiliary views showing enlargement of grooves in the back surface of the base plate;

FIG. 13 is a side elevational view of a stationary guide according to a fifth embodiment of the invention;

FIG. 14 is a transverse cross-sectional view taken on plane 14-14 in FIG. 13, including an enlarged auxiliary view showing a groove in the front surface of the base plate.

### DETAILED DESCRIPTION OF THE PREFERRED EMBODIMENTS

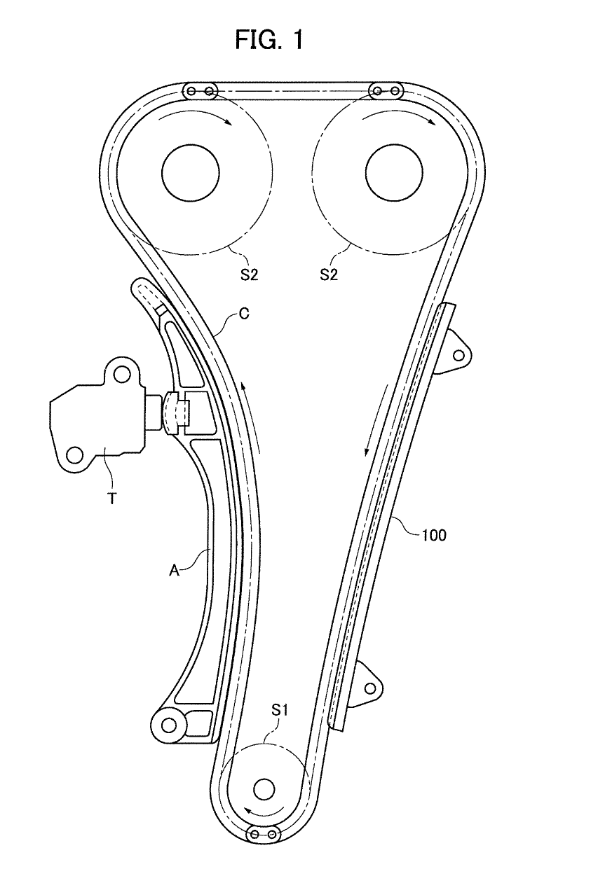

FIG. 1 shows a stationary guide 100 incorporated into the timing drive of a dual overhead cam (DOHC) internal combustion engine in which a chain C is driven by a crankshaft sprocket S1 and in driving relationship with a pair of camshaft sprockets S2. Arrows indicate the direction of travel of the timing chain C. The stationary guide 100 is in sliding contact with the span of a timing chain C that travels from a driven sprocket S2 toward the crankshaft sprocket S1. A pivoted tensioner lever A is pressed by the plunger of a tensioner T against a span of the than that travels from the crankshaft sprocket S1 toward the other camshaft sprocket 52.

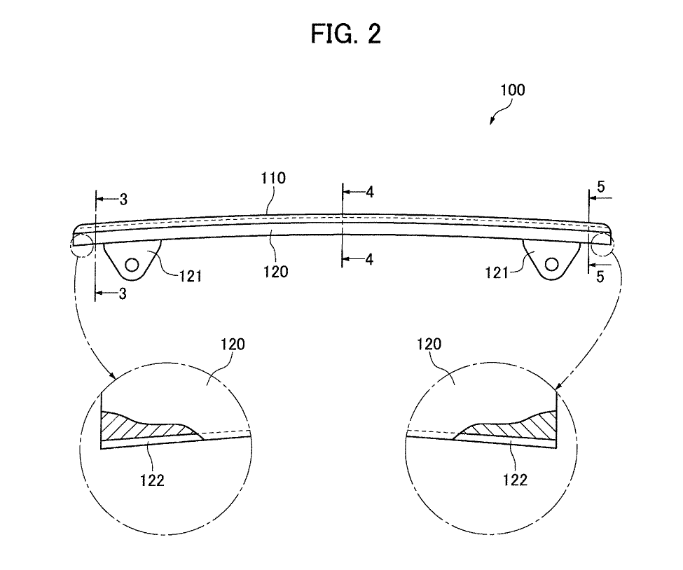

In the first embodiment of the stationary guide, illustrated in FIGS. 2-5, an elongated stationary guide 100 includes a shoe 110 having an elongated, convexly curved, sliding contact curved surface on which the timing chain C travels along the direction of elongation of the guide. The shoe 110 is preferably composed of a nylon resin, and the base plate 120, which extends along the back of the shoe 110, and supports the shoe, can be composed of steel, although other materials such as aluminum can be used.

The guide 100 has mounting brackets 121, which are preferably unitary parts of the base plate 120. Each of these mounting brackets 121 has a through hole for receiving a mounting bolt (not shown) by which the base plate is fixed to an engine block for fixing the base plate 120 to the engine. The brackets 121 are longitudinally spaced from each other, one being and located adjacent the chain entry end of the base plate 120 at the right side of FIG. 2, and the other being located adjacent the chain exit end of the base plate 120 at the left side of FIG. 2.

The stationary guide 100 is mounted on the engine in a position such that it is in sliding contact with, and guides, the span of chain C that travels toward the driving sprocket.

A narrow reinforcing groove 122 is formed on the back of the base plate 120. The groove extends along the longitudinal direction of the guide, i.e., along the direction of elongation of the guide. The grooved is formed by the use of a pressing tool, and without removal of material as in the case of formation a groove by machining. The pressing tool (not shown) includes a ridge that conforms to the desired shape of the groove. The pressing tool exerts compressive stress on the back surface of the base plate, causing the back surface of the base plate to become plastically deformed.

Because the formation of the groove 122 in the back surface of the base plate causes the base plate to exhibit plastic deformation, whereby a region of the base plate extending along the length of the groove becomes work-hardened. As a result, the strength of the base plate is significantly improved, its configuration is stabilized, and bending deformation of the base plate is suppressed when an excessive load in a timing chain traveling along the guide exerts a large compressive stress on the base plate.

As shown in FIG. 2, the narrow reinforcing groove 122 extends from one end of the base plate to the other end, the groove extending longitudinally in both directions beyond the locations of the mounting bolts, and preferably in both directions beyond the mounting brackets. Thus the work-hardened area extends along the base plate throughout a region extending longitudinally in both directions beyond the mounting bolts.

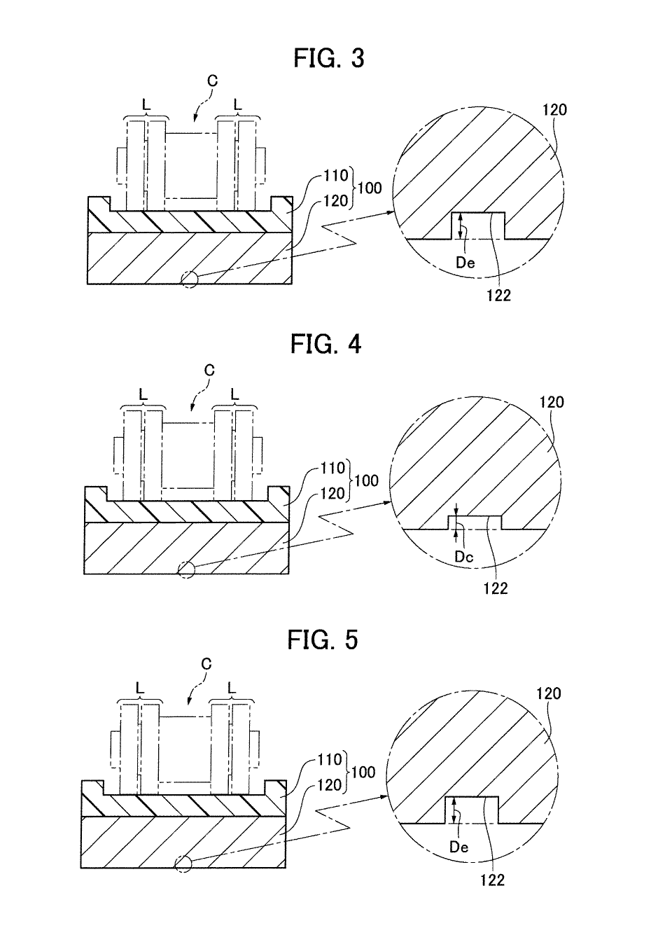

In the embodiment shown in FIGS. 2-5, the groove 122 becomes gradually deeper proceeding in the longitudinal direction from a central region toward the ends of the base plate. As shown in FIGS. 3 and 5, the depths De adjacent the ends of the narrow reinforcing groove 122 are greater than the depth Dc in the central region of the groove.

Because the narrow reinforcing groove 122 and the area of plastic deformation extend from a central region toward the respective ends of the base plate beyond the locations of the mounting bolts, it is possible to ensure stable travel of the timing chain C over a long time, without increasing the thickness of the base plate 120, to prevent bending deformation of the base plate along its longitudinal direction, and to achieve superior durability, even if the base plate is subjected to excessive load. It is also possible to avoid breakage, which would otherwise be likely to occur at the locations of the brackets where the mounting bolts secure the guide to an engine block.

Because the narrow reinforcing groove on the back of the base plate gradually becomes deeper, proceeding longitudinally from a central region toward both opposite ends of the guide, improved resistance to bending deformation of the base plate is achieved, when compared to a case in which the narrow reinforcing groove is of uniform depth along its length. In addition the gradual deepening of the groove proceeding from the central region toward the opposite ends of the groove produces greater work-hardening of the base plate near its ends, and the base plate becomes particularly resistant to breakage due to excessive impact loads caused by flapping of the timing chain in the free spans of the chain between the stationary guide and the adjacent driving and driven sprockets.

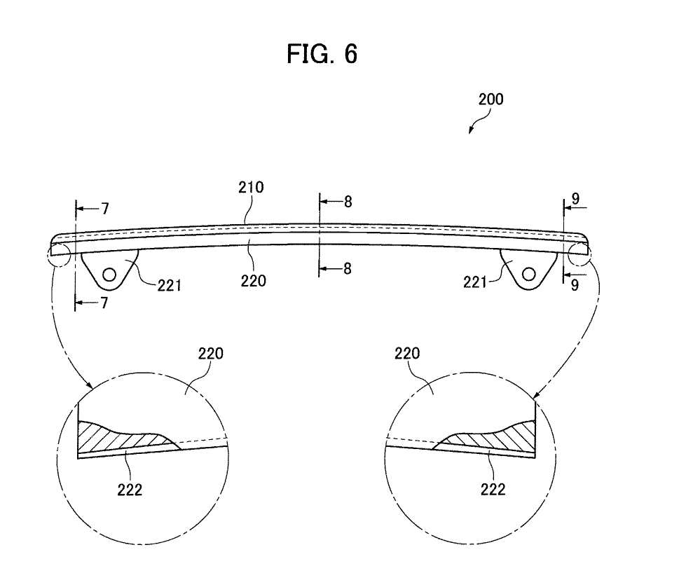

In the second embodiment, shown in FIGS. 6-9, the stationary guide 200 differs from guide 100 of the first embodiment only in the configuration of the narrow reinforcing groove. Parts in the second embodiment are identified by reference numbers that exceed by 100 the reference numbers of corresponding parts in the first embodiment.

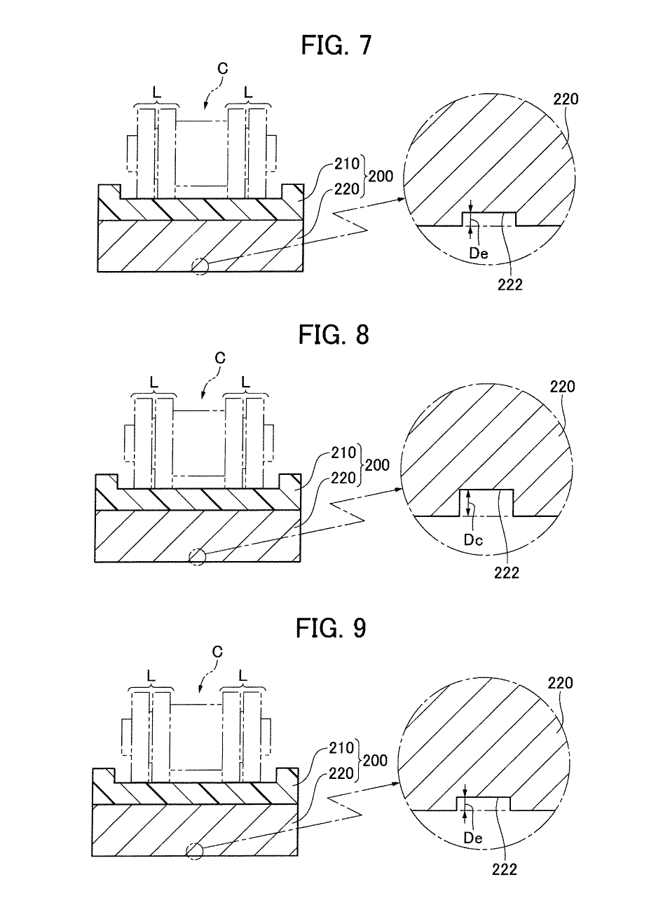

In the second embodiment, the narrow reinforcing groove 222, which extends longitudinally along the back of the base plate 220, gradually becomes deeper, proceeding from the ends of the guide toward its central region. Thus, as shown in FIGS. 7 and 9, the depth Dc of the groove at the central region is greater than the depth De adjacent the ends of the guide.

As in the first embodiment, improved resistance to bending deformation of the base plate is achieved, when compared to a case in which the narrow reinforcing groove is of uniform depth along its length. However, whereas the guide of the first embodiment exhibits improved resistance to breakage due to impact, because in the second embodiment, a greater degree of work-hardening occurs in the central region of the base plate, the guide of the second embodiment exhibits improved resistance to breakage due to excessive tension in the timing chain C.

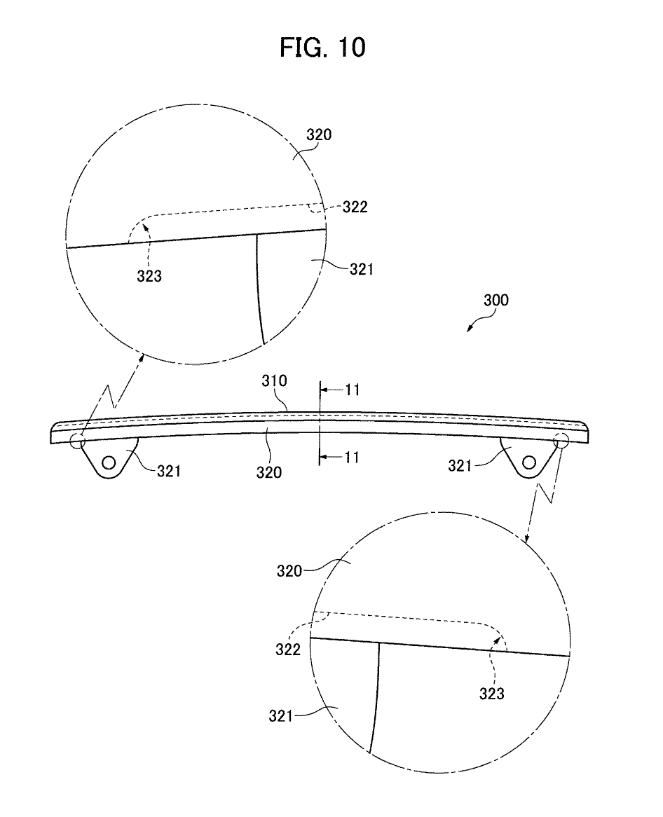

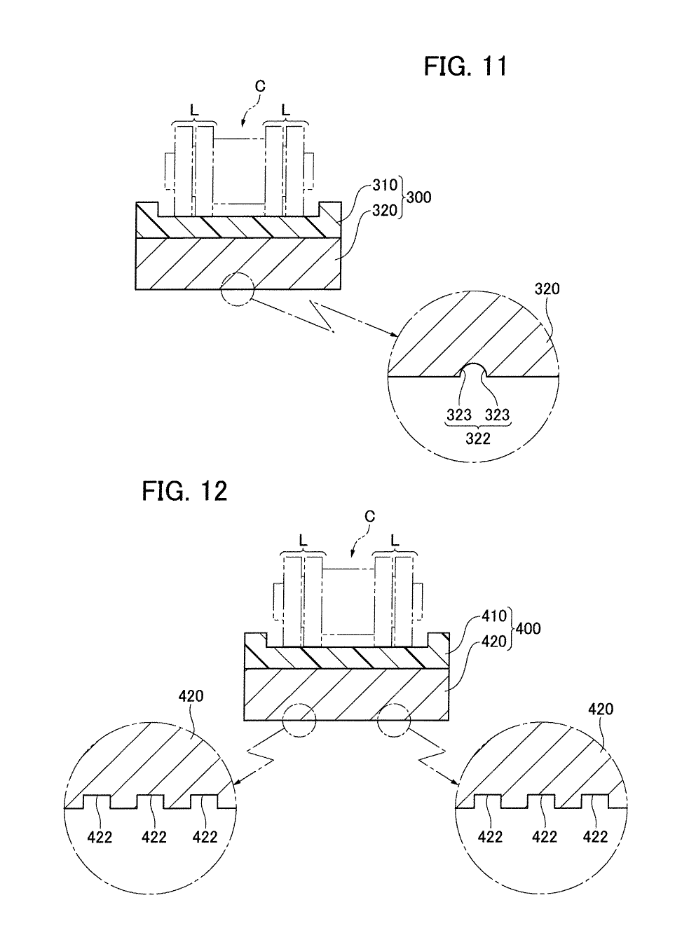

The third embodiment of an stationary guide of the invention, illustrated in FIGS. 10 and 11, differs from guide 100 of the first embodiment only in the configuration of the narrow reinforcing groove. Parts in the third embodiment are identified by reference numbers that exceed by 200 the reference numbers of corresponding parts in the first embodiment.

Groove ends 323 of the narrow reinforcing groove 322 along the guide longitudinal direction of the base plate 320 of the stationary guide 300 are bow-shaped, being in the form of concave curves, each extending from the back surface of the base plate to the bottom of the groove, as shown FIG. 10. In addition, the groove has a curved transverse cross-section, as shown in FIG. 11.

Accordingly, the stationary guide 300 exhibits effects similar to the effects common to the first and second embodiments. In addition, the bow-shaped groove ends 323 avoid concentration of stress, and afford improved resistance to breakage.

The fourth embodiment, illustrated in FIG. 12 differs from guide 100 of the first embodiment only in the configuration, number, and locations of the narrow reinforcing grooves. Parts in the fourth embodiment are identified by reference numbers that exceed by 300 the reference numbers of corresponding parts in the first embodiment.

Narrow reinforcing grooves 422, extend longitudinally along the back surface of the base plate 420 at positions opposite to the areas on the shoe 410 on which the link plates L of the timing chain C slide. In the embodiment shown, the narrow reinforcing grooves 422 are disposed in two sets each consisting of three parallel grooves, one set being opposite the link plates on the right side of the chain, and the other set being opposite the link plates on the left side of the chain.

In addition to the effects common to the first and second embodiments, the multiple grooves in the fourth embodiment provide for more effective radiant dissipation of the frictional heat caused by the sliding of link plates L on the shoe of the guide. In addition, plastic deformation of the base plate 420 is dispersed in over the width of the guide. Therefore, not only does the guide suppress deformation along its longitudinal direction, but improved resistance to deformation due to forces exerted by the link plates is achieved by positioning the reinforcing grooves opposite from the areas on which the link plates slide. In addition the plural grooves distributed over the width of the base plate assist in preventing the base plate 420 from twisting.

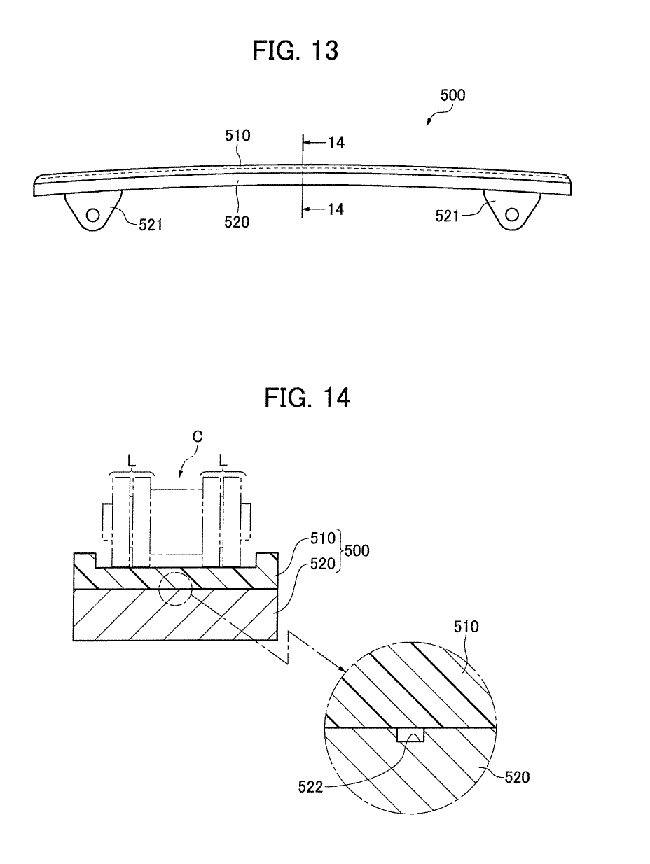

The fifth embodiment, illustrated in FIGS. 13 and 14, differs from guide 100 of the first embodiment only in the location of the narrow reinforcing groove. Parts in the fifth embodiment are identified by reference numbers that exceed by 400 the reference numbers of corresponding parts in the first embodiment.

A narrow, longitudinally extending reinforcing groove 522, having a rectangular transverse cross-section, is formed, by surface pressing, on the surface of the base plate 520 facing the shoe 510.

In addition to the effects common to the first and second embodiments, the stationary guide 500 has the advantage that its narrow reinforcing functions as a longitudinal oil passage through which lubricating oil can flow to carry off excess frictional heat produced as the timing chain C slides on shoe 510. Removal of heat is especially desirable in the high temperature environment of an engine. To ensure effective removal of heat by the flow of lubricating oil, it is desirable to avoid narrowing of the groove 522. Thus, in producing the guide according to the fifth embodiment, the surface pressing process is preferably carried out in such a way as to avoid even subtle variations in the depth and width of the groove, and, to this end, wear of the surface pressing tool should be avoided.

The base plate used in the stationary guide according to the invention is preferably a metal such as steel or aluminum, both of which can have sufficient durability to withstand fluctuations in chain tension in the high-temperature environment of an engine. Aluminum has advantages for the base plate because of its lighter weight.

The curvature of the base plate can vary along its length. For example, the regions adjacent the entry and exit ends of the base plate can have a small radius of curvature while the region between the entry and exit end regions can have a larger radius of curvature. Alternatively, the regions adjacent the entry and exit ends of the base plate can have a small radius of curvature while the region between the entry and exit end regions can be straight.

Surface pressing to form the narrow reinforcing groove or grooves will considerably improve the strength of the base plate by exerting compressive stress on the base plate, thereby stabilizing its configuration by plastic deformation of its surface. The reinforcing groove should extend in both longitudinal directions beyond the locations of the mounting bolts and preferably extends beyond the locations of the mounting brackets.

The transverse cross-section of the narrow reinforcing groove can be any of various concave shapes such as a rectangular, semi-circular or inverted triangular shape. The rectangular and semi-circular shapes have advantages in production because they avoid rapid wear of the surface of the pressing tool.

It is possible to change the strength and rigidity of the base plate along its longitudinal direction by varying the depth of the narrow reinforcing groove along its length. Thus, as mentioned previously, the groove can be deepest at the end regions and shallower in the central region, or alternatively, deepest in the central region and shallowest at the end regions.

It is also possible to vary the strength and rigidity of the base plate along its length by varying the width of the narrow reinforcing groove. For example, the narrow reinforcing groove can be wider at the ends of the base plate than in the central region, or, alternatively, wider in the central region than at the ends.

What is claimed is:

1. A stationary guide for a transmission chain in an engine, the guide comprising:
an elongated shoe having a front surface for sliding contact with a transmission chain traveling along the direction of elongation of the shoe, and a back surface, said front and back surfaces being curved along the direction of elongation of the shoe; and
an elongated metal base plate also having front and back surfaces, the base plate having opposite ends and extending along the direction of elongation of the shoe, and the front surface of the base plate being in contact with the back surface of the shoe, whereby the shoe is supported by the base plate, said base plate also including at least two longitudinally spaced brackets for receiving mounting bolts for mounting the base plate on an engine, said brackets being located along the length of the base plate at locations between said opposite ends of the base plate;
in which at least one of said front and back surfaces of the base plate is plastically deformed to an extent such that it has a narrow reinforcing groove extending along the direction of elongation of the base plate; and
in which said narrow reinforcing groove extends longitudinally past both of said brackets toward opposite ends of the base plate.

2. The stationary guide according to claim 1, wherein the narrow reinforcing groove is formed so that the groove becomes gradually deeper, proceeding from an intermediate region between said opposite ends toward each of said opposite ends.

3. The stationary guide according to claim 1, wherein the narrow reinforcing groove is formed so that the groove becomes gradually deeper, proceeding from each of said opposite ends toward an intermediate region between said opposite ends.

4. The stationary guide according to claim 1, wherein the narrow reinforcing groove has bow-shaped ends in the form of concave curves, each extending from said at least one of said front and back surfaces of the base plate to the bottom of the groove.

5. In a chain transmission comprising a traveling transmission chain having link plates, a stationary guide according to claim 1, wherein at least one of said front and back surfaces of the base plate is plastically deformed to an extent such that it has at least two parallel, narrow, reinforcing groove extending along the direction of elongation of the base plate, each of said narrow reinforcing grooves extends longitudinally past both of said brackets toward opposite ends of the base plate, the chain is in sliding contact with the front surface of the shoe with its link plates in sliding contact with the shoe in an area having a width substantially equal to the width of the chain, and said reinforcing grooves are located opposite said area, the outermost reinforcing grooves being substantially directly opposite the sides of said area.

6. In a chain transmission comprising a traveling transmission chain having laterally spaces sets of link plates, a stationary guide according to claim 1, wherein at least one of said front and back surfaces of the base plate is plastically deformed to an extent such that it has two parallel, narrow, reinforcing groove extending along the direction of elongation of the base plate, each of said narrow reinforcing grooves extends longitudinally past both of said brackets toward opposite ends of the base plate, the chain is in sliding contact with the front surface of the shoe, and said reinforcing grooves are laterally spaced from each other by a distance substantially the same as the distance between said sets of link plates of the chain, each of said reinforcing grooves being located directly opposite one of said sets of link plates.

7. The stationary guide according to claim 1, wherein the narrow reinforcing groove is formed in the front surface of the base plate and has a rectangular cross-sectional shape.

8. The stationary guide according to claim 1, wherein at least one of said front and back surfaces of the base plate is plastically deformed to an extent such that it has at least two parallel, narrow, reinforcing groove extending along the direction of elongation of the base plate, each of said narrow reinforcing grooves extends longitudinally past both of said brackets toward opposite ends of the base plate.

9. The stationary guide according to claim 1, wherein said narrow reinforcing groove is formed by plastically deforming the base plate by exerting compressive stress on one of said front and back surfaces the base plate by means of a pressing tool.
